(19) United States
(12) Patent Application Publication
(10) Pub. No.: US 2007/0233645 A1
(43) Pub. Date: Oct. 4, 2007

(54) System and Method for Building an XQuery Using a Model-Based XQuery Building Tool

(76) Inventors: Trenten Peterson, Florence, TX (US); Hardeep Singh, Fremont, CA (US)

Correspondence Address: IBM CORPORATION - SVL (JVL);C/O VANLEEUWEN & VANLEEUWEN, P.O. BOX 90609, AUSTIN, TX, 78709-0609, US

(21) Appl. No.: 11/277,693

(22) Filed: Mar. 28, 2006

(51) Int. Cl. G06F 17/30

(52) U.S. Cl. 707/3

(57) ABSTRACT

A system and method for building an XQuery using a model-based XQuery building tool is presented. An XQuery builder includes a general user interface (GUI) that enables a user to graphically interpret XML source documents and create a query model. The XQuery builder then optimizes the query model by generating relative paths for nodes and converting FLWOR expressions to XPath expressions. In addition, the XQuery builder inserts runtime parameters into the query model that correspond to XML documents that are required to test the XQuery. Subsequently, the XQuery builder generates an XQuery from the optimized query model, and provides the XQuery and required XML documents to a query engine that, in turn, produces query results.

### BACKGROUND OF THE INVENTION

1. Technical Field

The present invention relates to a system and method for building an XQuery using a model-based XQuery building tool. More particularly, the present invention relates to a system and method for optimizing a query model that is built from existing node structures and generating an XQuery from the optimized query model.

2. Description of the Related Art

Extensible Markup Language (XML) is a versatile markup language that labels information content over diverse data sources, including structured documents, semi-structured documents, relational databases, and object repositories.

As increasing amounts of information are stored, exchanged, and presented using XML, the ability to intelligently query XML data sources becomes increasingly important. One of XML's strengths is its flexibility in representing many different information types from diverse sources. To exploit this flexibility, an XML query language, called XQuery, has been developed.

XQuery provides concise and easily understood queries, and is also flexible enough to query a broad spectrum of data sources, including both databases and documents. Some of these data sources may be available when a user writes and tests an XQuery, while other data sources may not be available, such as a new, unpopulated database. In addition, some data sources may only be available to the query at run-time, such as when a query executes within a running program (e.g., web-service request). When a data source is not available, a user must pass the data to the XQuery via parameter bindings when testing an XQuery. A challenge found with this approach is that manually coding these parameters is a cumbersome process.

Another challenge found for a user is the process of creating an XQuery. Typically, a user starts with a source schema and a target schema. The user analyzes the target schema, identifies an instance document structure adhering to that schema, and builds an XQuery using node constructors corresponding to the instance document structure, as well as new node constructors where applicable. As expected, this approach is a time consuming and error prone process, especially for XQuery novice users who must first learn nesting node constructors and query logic syntaxes.

Furthermore, another challenge found with creating an XQuery is generating relative paths for XPath elements. When a user selects an XML node from an XML document, the node may be represented in an XQuery model as an “absolute” path, which is a path anchored at the root node of the XML document and extending to a selected node. Although the node path is represented as an absolute path in the XQuery model, the node may be represented in the resulting XQuery code as a relative path that starts at a variable and includes a path from the variable to the document's root node. Thus, a node may be identified in an XQuery by the combination of an absolute path (contained in the variable) and a relative path (from the variable to the node). If this path combination is itself held in a variable, another node in the XQuery model may be represented in the XQuery code as a path relative to that variable, thus minimizing the size and complexity of the paths in the query. In order to have sensible and efficient relative paths, an XQuery tool must generate them from the absolute paths described in the model. Existing art, however, requires a user to identify the relative paths during XQuery development. Again, because XQuery is a fairly complicated scripting language, this approach is a difficult and error prone process, especially for novices.

Finally, another challenge found with XQuery development is the ability to convert For-Let-Where-Orderby-Return (FLWOR) expressions, which are useful when writing an XQuery, to XPath expressions during XQuery execution, which increases the readability of the XQuery. The difference between an XPath expression and a FLWOR expression is that a FLWOR expression is more verbose and explicit, which allows a user to view the logic behind its corresponding XPath expression. Thus, when writing an XQuery, a user may prefer to view FLWOR expressions instead of XPath expressions. XPath expressions, however, are easier to read when viewing the XQuery as a whole. Therefore, it would be desirable to automatically identify appropriate FLWOR expressions and convert the FLWOR expressions to XPath expressions.

What is needed, therefore, is a system and method for automating XQuery generation steps in order to alleviate the challenges discussed above.

### SUMMARY

It has been discovered that the aforementioned challenges are resolved using a system, method, and program product that generates an XQuery by identifying an object in a query model and determine that the object is an XPath object. The system, method, and program product then create a relative path for the XPath object that corresponds to a hierarchical location of the XPath object relative to other objects included in the query model. The system, method, and program product then include the relative path in the query model. Once the relative path is included in the query model, the system, method, and program product generate an XQuery using the query model.

Finally, the system, method, and program product execute the generated XQuery using a query engine.

In one embodiment, the system, method, and program product annotate, for the XPath object, an absolute path in the query model, a parent's absolute path that corresponds to a parent object of the XPath object, and a model tree level. In this embodiment, the system, method, and program product include the annotated absolute path, parent's absolute path, and the model tree level in the relative path. When the XPath object represents a variable, the system, method, and program product annotate a variable name and a variable type that corresponds to the variable, and include the variable name and variable type in the relative path.

In one embodiment, the system, method, and program product select a nearest ancestor to the XPath object. In this embodiment, the system, method, and program product identify a nearest ancestor variable path offset that corresponds to the selected nearest ancestor and includes the nearest ancestor variable path offset in the relative path.

In one embodiment, the system, method, and program product identify a For-Let-Where-Orderby-Return (FLWOR) object in the query model. In this embodiment, the system, method, and program product determine whether the FLWOR object is convertible to an XPath object based upon one or more convertibility rules. When the system, method, and program product determine that the FLWOR object is convertible, the system, method, and program product convert the FLWOR object to the XPath object using one or more conversion rules.

In one embodiment, the system, method, and program product identify an XML instance document and select a node included in the XML instance document. Once selected, the system, method, and program product replicate the node into the query model using a general user interface that results in the object. In another embodiment, the system, method, and program product determine that the XML instance document is used during query execution and the XML instance document is bound to a file. In this embodiment, the system, method, and program product generate a runtime parameter that corresponds to the XML instance document and include the runtime parameter in the XQuery.

In another embodiment, in response to determining that the XLM instance document is used during query execution and the XML instance document is bound to a file, the system, method, and program product pass the XML document as a runtime parameter to the query engine during the query execution.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings.

FIG. 1 is a diagram showing an XQuery builder creating a query model and generating an XQuery from the query model;

FIG. 2 is a high-level flowchart showing steps taken in generating and executing an XQuery from a query model;

FIG. 3 is a flowchart showing steps taken in identifying and creating relative paths for XPath objects that are included in a query model;

FIG. 4 is a flowchart showing steps taken in generating relative paths for XPath objects;

FIG. 5 is a flowchart showing steps taken in converting FLWOR objects to XPath objects;

FIG. 6 is a flowchart showing steps taken in creating runtime parameters for an XQuery using XML source documents;

FIG. 7 is a flowchart showing steps taken in passing documents as runtime parameters to a query engine during an XQuery execution;

FIG. 8A is a general user interface (GUI) window that allows a user to select a node to replicate into a query model;

FIG. 8B is a user interface window showing an instance document node replicated in a query model;

FIG. 9 is a window showing query model code that includes XPath elements;

FIG. 10A is a window showing query model code that includes annotated XPath elements;

FIG. 10B is a window showing query model code that includes annotated XPath elements and relative paths;

FIG. 11A is a diagram showing a query model hierarchy that includes FLWOR objects;

FIG. 11B is a diagram showing a first recursive step result for converting FLWOR objects to XPath objects;

FIG. 12A is a diagram showing a second recursive step result for converting FLWOR objects to XPath objects;

FIG. 12B is a diagram showing a third recursive step result for converting FLWOR objects to XPath objects;

FIG. 13A is a window showing a query model in XML code that includes document information;

FIG. 13B is a window showing XSLT code for use in generating a parameterized query;

FIG. 14 is a window showing an example of Java code for use in passing example documents to a query engine during query execution; and

FIG. 15 is a block diagram of a computing device capable of implementing the present invention.

### DETAILED DESCRIPTION

The following is intended to provide a detailed description of an example of the invention and should not be taken to be limiting of the invention itself. Rather, any number of variations may fall within the scope of the invention, which is defined in the claims following the description.

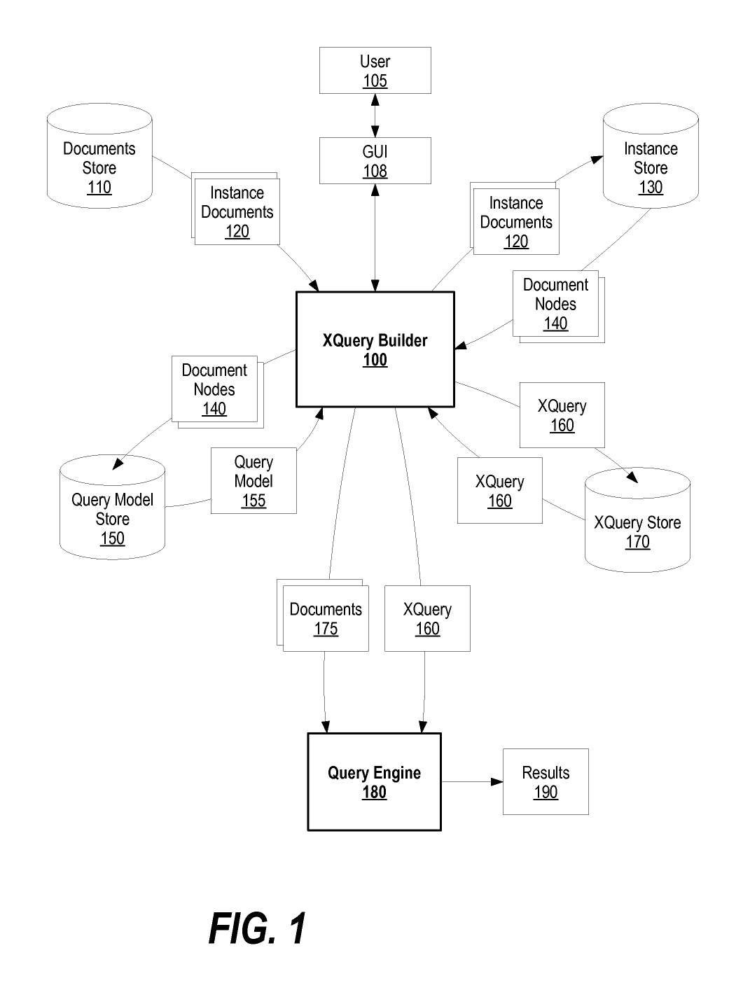

FIG. 1 is a diagram showing an XQuery builder creating a query model and generating an XQuery from the query model. XQuery builder 100 enables a user, such as user 105, to graphically interpret XML source documents and create a query model using general user interface (GUI) 108. XQuery builder 100 then optimizes the query model and generates an XQuery. In turn, a query engine (query engine 180) executes the XQuery and returns results.

User 105 uses GUI 108 to identify instance documents 120, which are located in documents store 110, that include node examples that are similar to results (results 190) that user 105 wishes to receive from an XQuery. XQuery builder 100 retrieves user 105's identified documents (instance documents 120) from documents store 110 and stores them in instance store 130. Documents store 110 and instance store 130 may be stored on a nonvolatile storage area, such as a computer hard drive.

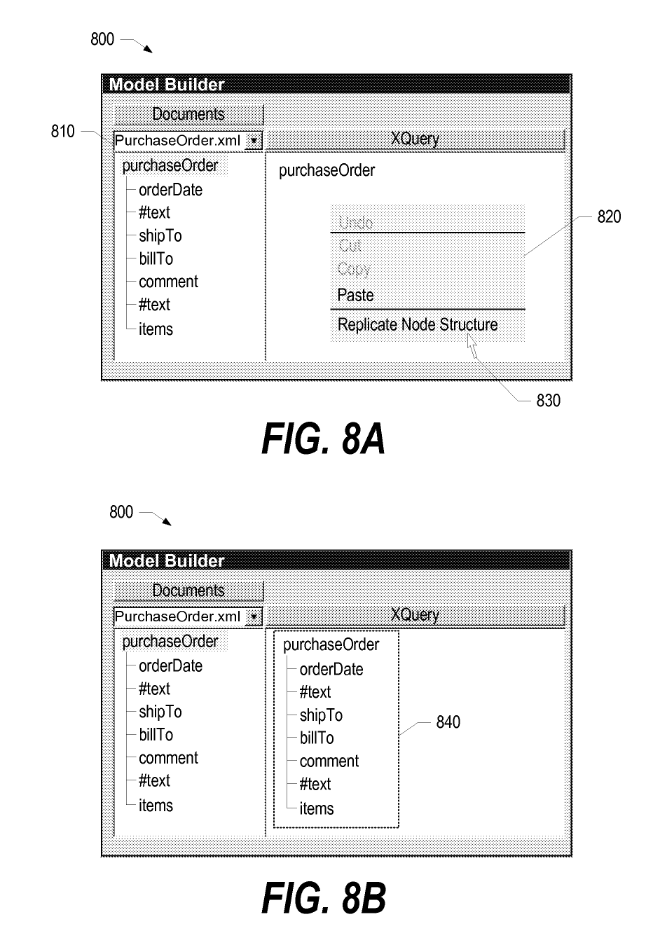

User 105 then uses GUI 108 to replicate the nodes included in instance documents 120 that are similar to the results that user 105 wises to receive. GUI 108 may include two window areas, whereby the first area includes the nodes included in instance document 120 and the other area is a replication area that shows replicated nodes (see FIGS. 8A, 8B, and corresponding text for further details). XQuery builder 100 replicates the nodes included in instance documents, and stores the replicated nodes (document nodes 140) in a query model located in query model store 150. Query model store 150 may be stored on a nonvolatile storage area, such as a computer hard drive.

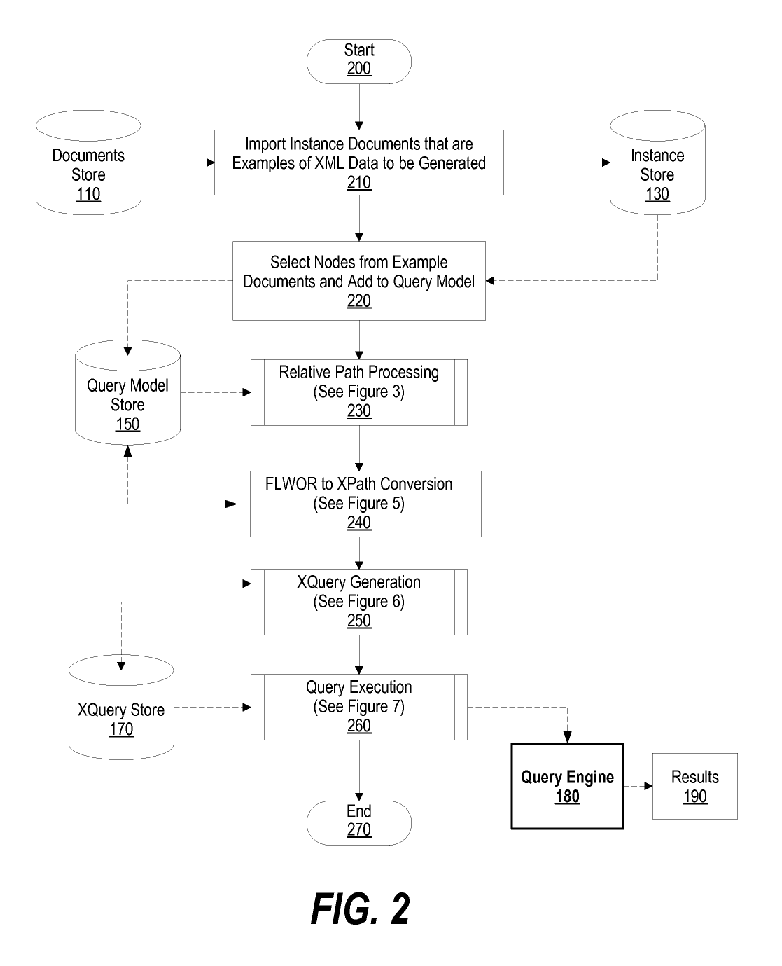

When user 105 is finished replicating nodes, XQuery builder 100 retrieves query model 155 from query model store 150, and proceeds through a series of actions to optimize query model 155 prior to generating an XQuery. These optimization steps include generating relative paths for XPath objects in order to minimize the size and complexity of the paths in the query. In addition, XQuery builder 100 analyzes For-Let-Where-Orderby-Return (FLWOR) objects and converts the FLWOR objects to XPath objects if appropriate (see FIGS. 2 through 5, and corresponding text for further details).

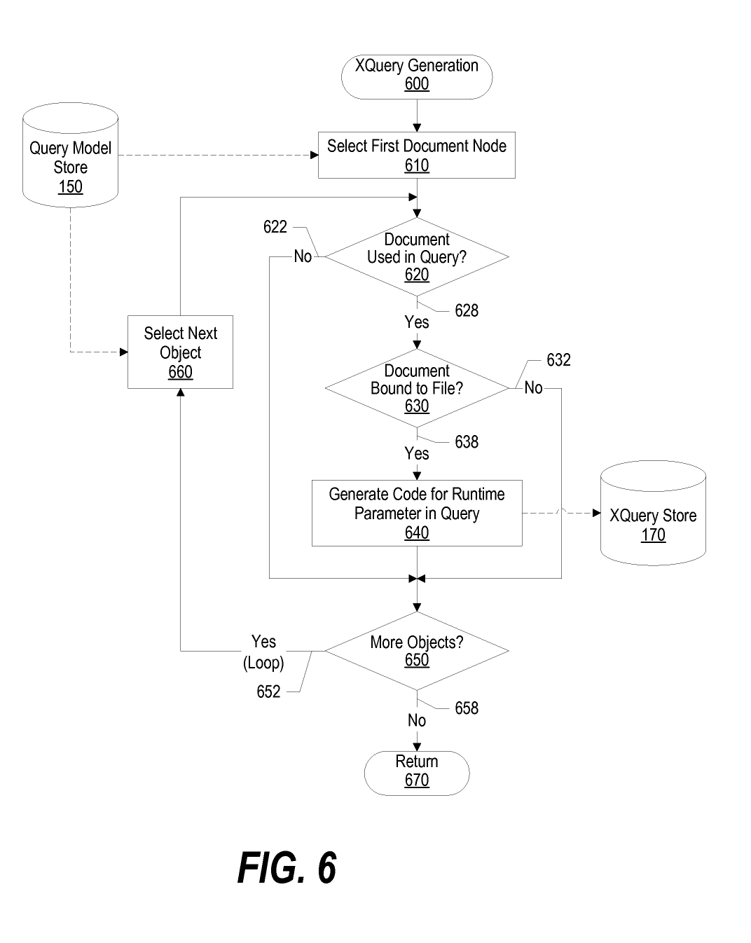

Once XQuery builder 100 optimizes query model 155, XQuery builder 100 generates XQuery 160 using the optimized query model, and stores XQuery 160 in XQuery store 170. During XQuery 160 generation, XQuery builder 100 identifies documents that the query uses, which are bound to a file, and generates corresponding runtime parameters. These runtime parameters are included in XQuery 160 (see FIG. 6 and corresponding text for further details).

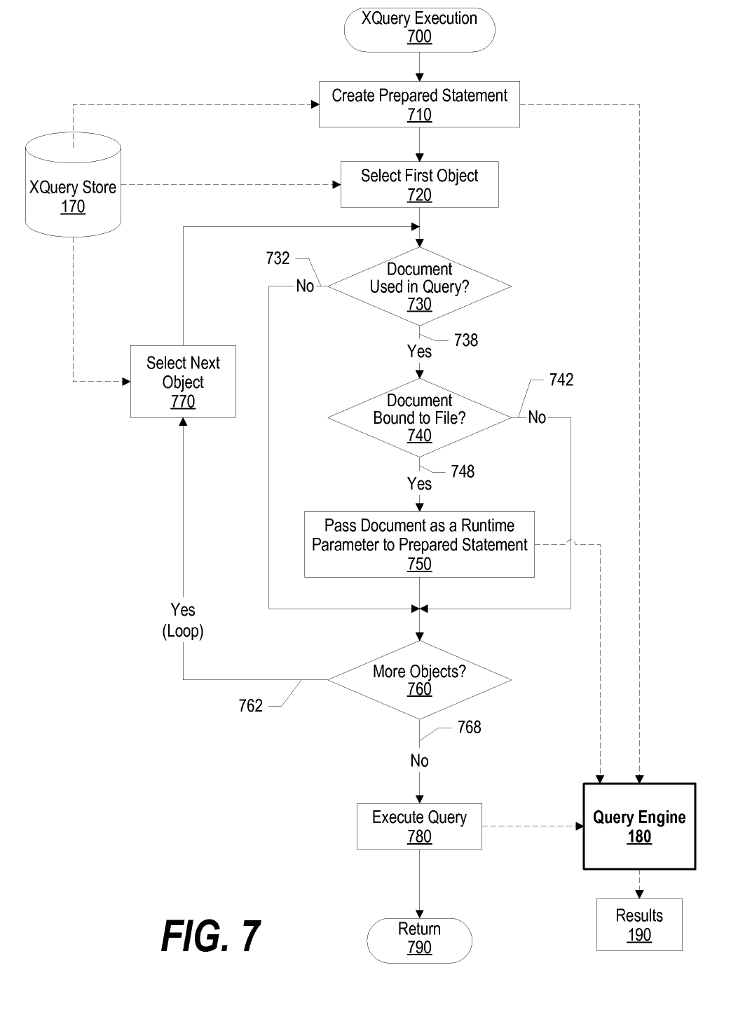

XQuery 160 is now ready for execution. XQuery builder 100 retrieves XQuery 160 from XQuery store 170, and passes it to query engine 180. In addition, in order to test XQuery 160, XQuery builder 100 passes documents 175 to query engine 180, which are the XML documents that XQuery builder 100 identified earlier as being used in the query and bound to a file (discussed above). Query engine 180 uses XQuery 160 and documents 175 to generate results 190 for user 105 to view (see FIG. 7 and corresponding text for further details).

FIG. 2 is a high-level flowchart showing steps taken in generating and executing an XQuery from a query model. Processing commences at 200, whereupon processing imports instance documents from documents store 110 into instance store 130, which include nodes that represent XQuery results that a user wises to receive (step 210). Documents store 110 and instance store 130 are the same as that shown in FIG. 1.

At step 220, processing uses a GUI interface to replicate nodes from the instance documents into a query model that is located in query model store 150 (step 220). The GUI interface combines a flexible query building tool as a context and provides a user with the choice of selecting and replicating a node, which are associated with a query output. (see FIGS. 8A, 8B, and corresponding text for further details). Query model store 150 is the same as that shown in FIG. 1.

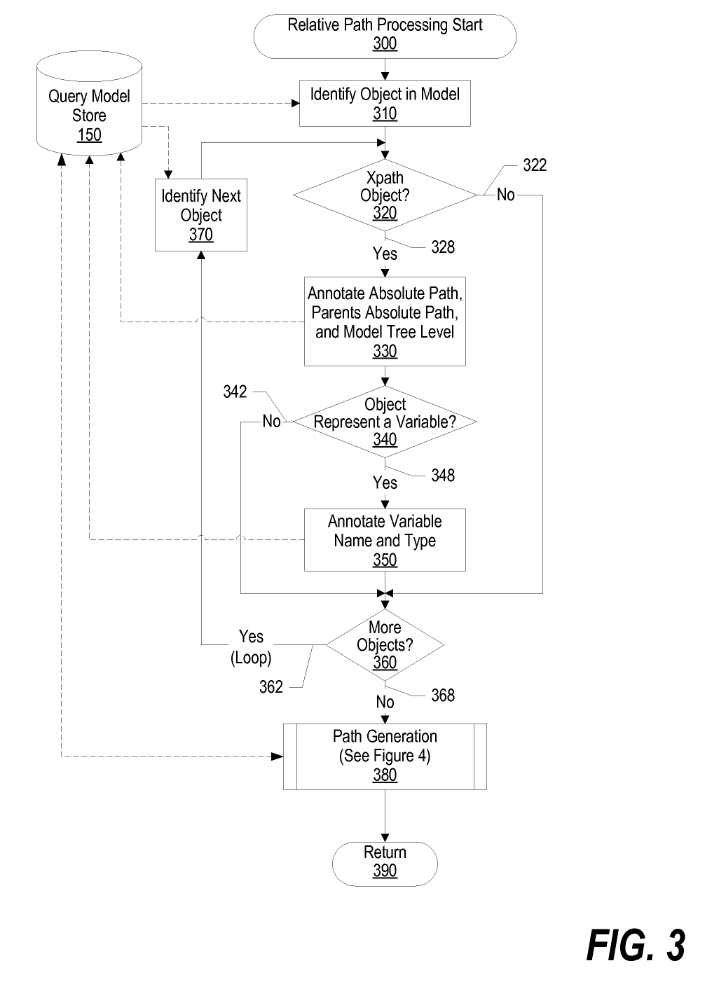

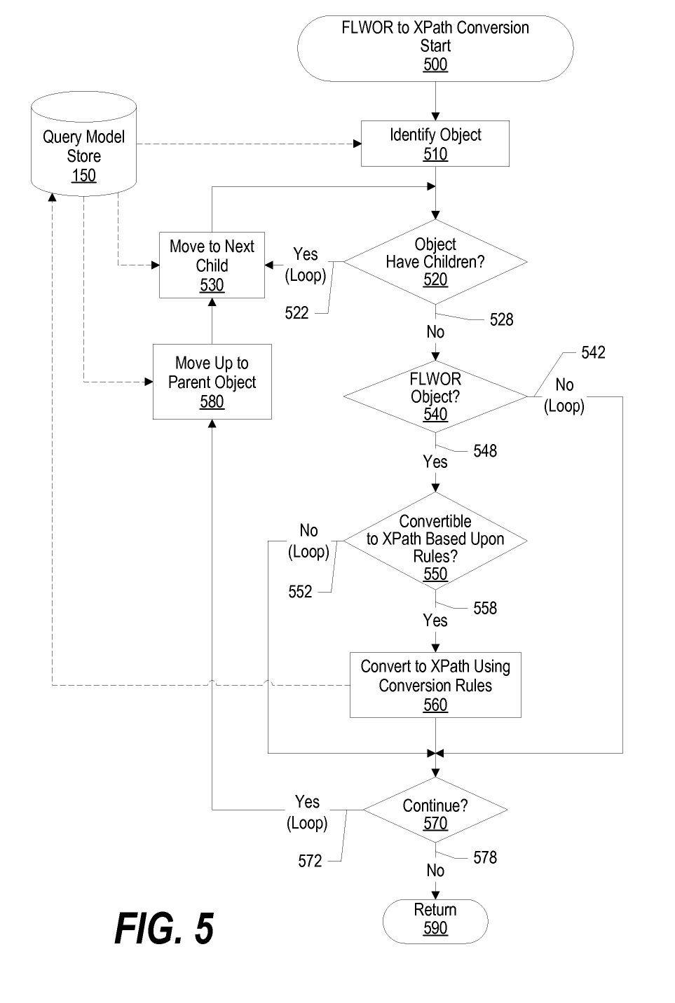

Processing automatically generates sensible and efficient relative path information from absolute path information that describes non-replicated nodes whose associated path is a path in the source document (pre-defined process block 230, see FIG. 3 and corresponding text for further details). At step 240, processing recursively traverses the query model included in query model store 150, starting from the innermost FLWOR object and using configurable rules, to convert FLWOR objects to XPath objects wherever applicable (pre-defined process block 240, see FIG. 5 and corresponding text for further details).

Once relative paths are in place and FLWOR objects are converted to XPath objects, processing generates an XQuery using the query model, and stores the XQuery in XQuery store 170 (pre-defined process block 250, see FIG. 6 and corresponding text for further details). During the XQuery generation, processing includes runtime parameters for documents that are used in the query and bound to a file. XQuery store 170 is the same as that shown in FIG. 1.

Processing executes the generated XQuery using query engine 180, which produces results 190. To test the XQuery, processing passes documents that the XQuery uses, which are bound to a file, as input parameters to query engine 180 (pre-defined process block 260, see FIG. 7 and corresponding text for further details). Query engine 180 and results 190 are the same as that shown in FIG. 1. Processing ends at 270.

FIG. 3 is a flowchart showing steps taken in identifying and creating relative paths for XPath objects that are included in a query model. The query model includes a hierarchy of objects, whose positions in the model are typically described using an “absolute path.” These objects are taken out of a hierarchical position, and laid “flat”, or listed sequentially. As a result, each object includes both a reference to its position in a corresponding XML document, and a reference to its position in the model. Thus, the object is identified in XQuery code by the combination of the absolute path (contained in a variable), and the relative path (from the variable context) to the node. By having the combination of paths stored in a variable, other nodes in the query model may be represented in the XQuery as a path relative to that variable. In addition, a variable may also represent a sequence of nodes, which are filtered during the process of creating the variable.

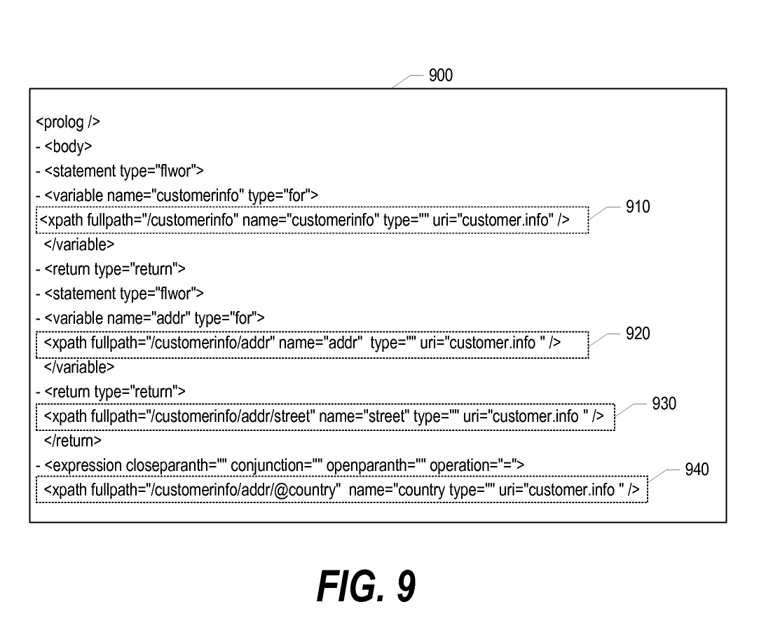

Processing commences at 300, whereupon processing identifies an object in the query model located in query model store 150 (step 310). Query model store 150 is the same as that shown in FIG. 1. A determination is made as to whether the object is an XPath object (decision 320). If the object is not an XPath object, decision 320 branches to “No” branch 322 bypassing annotation steps. On the other hand, of the object is an XPath object, decision 320 branches to “Yes” branch 328 whereupon processing “flattens” the object by annotating the object's absolute path in the query model, its parent's absolute path, its model tree level, and stores the information back into the query model in query model store 150 (step 330) (see FIG. 9 and corresponding text for further details).

A determination is made as to whether the object represents a variable (decision 340). For example, the object may be a child of an Object of type “FOR” or “LET.” If the object does not represent a variable, decision 340 branches to “No” branch 342 bypassing variable annotation steps. On the other hand, if the object represents a variable, decision 340 branches to “Yes” branch 348 whereupon processing annotates the object's corresponding variable name and type, and stores it back in the query model located in query model store 150 (step 350) (see FIG. 9 and corresponding text for further details).

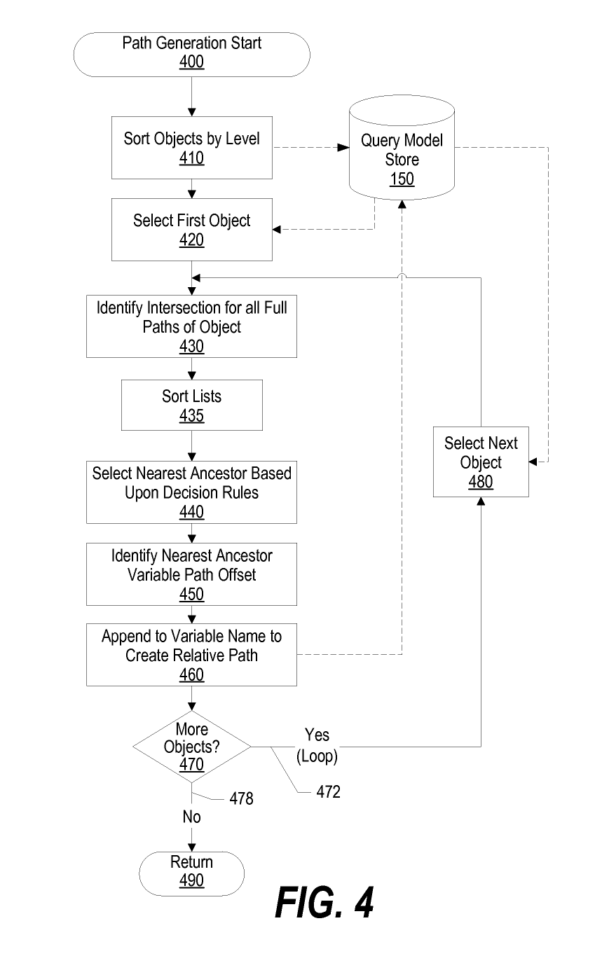

A determination is made as to whether the query model includes more objects (decision 360). If the query model includes more objects, decision 360 branches to “Yes” branch 362 whereupon processing identifies (step 370) and processes the next object. This looping continues until there are no more objects to process, at which point decision 360 branches to “No” branch 368 whereupon processing generates a relative path for the XPath objects and stores the relative paths back into the query located in query store 150 (pre-defined process block 380, see FIG. 4 and corresponding text for further details). Processing returns at 390.

FIG. 4 is a flowchart showing steps taken in generating relative paths for XPath objects. The XPath objects were “flattened” during steps shown in FIG. 3, which changed them from a hierarchal level to single level that includes their hierarchal information.

Processing commences at 400, whereupon processing sorts the annotated objects included in query model store 150 by level (e.g., ascending order) at step 410. At step 420, processing selects the first object from the sorted objects and, at step 430, processing performs a path intersection for the full path values of the other objects in order to locate a common ancestor in the object's corresponding XML source document. For example, processing may compare strings starting from a root node to find overlapping paths. At step 435, processing sorts the list using the intersection point with the nearest intersection path that is higher in the list.

At step 440, processing applies “nearest ancestor decision rules” and selects the most appropriate nearest ancestor variable. For example, the rules may include:
Use the closest variable in the model;
If an XPath expression is included in a RETURN statement of an XQuery FLWOR statement, first check the LET expression, and then check the FOR variables;
If an XPath expression is in an ORDERBY statement of an XQuery FLWOR statement, only check the FOR variables;
If an XPath expression is in a WHERE statement of an XQuery FLWOR statement, first check the FOR variables, and then the LET variables;
If two or more variables are equally relevant, select the first variable;
Select variables that are defined in a model's direct path first.

Processing, at step 450, identifies a nearest ancestor variable path offset. For example, the intersection between the absolute path to a target node and the absolute path to its nearest ancestor node may be used to calculate the relative path of an object to the target node using a formula such as:
Relative path=$+variablename+(count_subpaths (relevant variable path−Intersection path)) * “..”+(target object path−Intersection path)
where:
target=model object for which the relative path is being computed;
variable=A model object that contains or describes a path from the document root that is the most relevant nearest ancestor;
target path=path of the target object from the document root;
variable path=path defined by the variable from the root of the document;
variablename=Name given to the variable by the tools user;
intersection path=part of the variable path that overlaps with the path of the target node;
variable path=Intersection path: that part of the variable path that does not overlap with the target object path;
target object path=Intersection path: that part of the target object path that does not overlap with the variable path;
count_subpaths( . . . )=the number of nodes separated by “/” in the path argument;
count_subpaths( . . . ) * “.. ”=For each count, add the string “.. ” separated by a “/”.

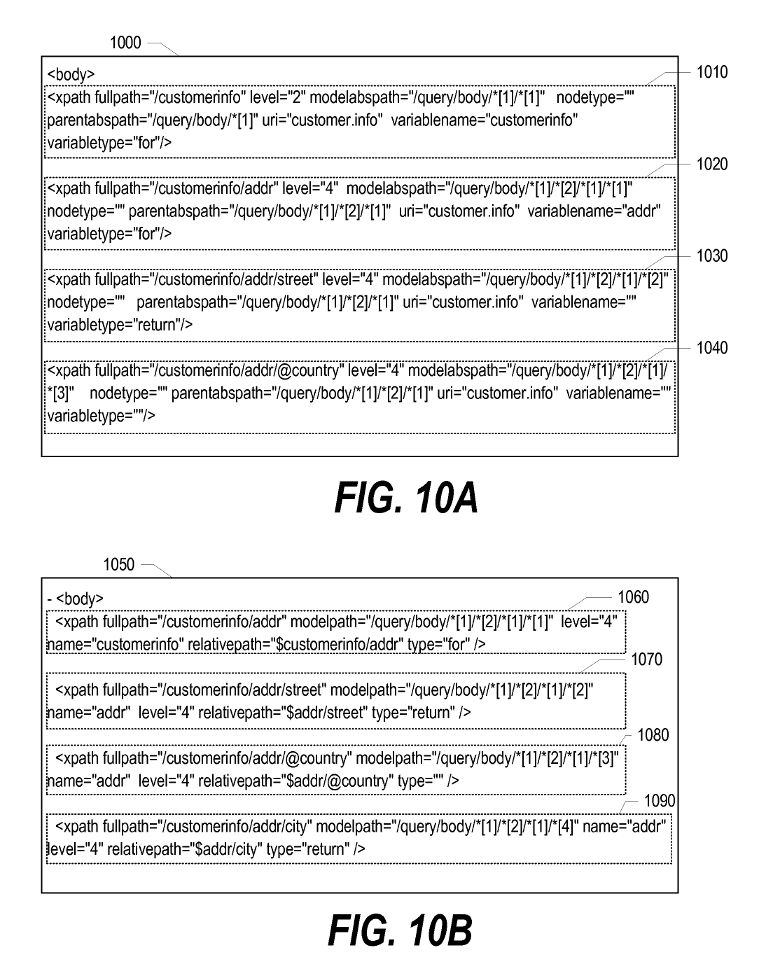

At step 460, processing appends the variable name to the object in query model store 150, which creates a relative path for the object (see FIG. 10B and corresponding text for further details).

A determination is made as to whether there are more objects to process (decision 470). If there are more objects to process, decision 470 branches to “Yes” branch 472 whereupon processing selects (step 480) and processes the next object. This looping continues until there are no more objects to process, at which point decision 470 branches to “No” branch 478 whereupon processing returns at 490.

FIG. 5 is a flowchart showing steps taken in converting FLWOR objects to XPath objects. In an XQuery, an XPath object may be expressed as an equivalent “For-Let-Where-Orderby-Return” (FLWOR) object. The main difference between an XPath object and a FLWOR object is that the FLWOR object is more verbose and explicit, which exposes logic behind the XPATH object for a user to view.

When writing an XQuery, it is therefore helpful to view XPath objects as FLOWR objects because the logic is more easily understood and manipulated. However, a concise XPath object is typically easier to read in the context of the entire query than the verbose FLWOR object. A FLWOR object may include other FLWOR objects that, in turn, may also include more FLWOR objects. In order to convert FLWOR objects to XPath objects, an XQuery builder recursively traverses a query model's hierarchy, starting from the innermost FLWOR object.

Conversion processing commences at 500, whereupon processing identifies an object in the query located in query store 150 (step 510). Query model store 150 is the same as that shown in FIG. 1. A determination is made as to whether the object has child objects (decision 520). If the object has child objects, decision 520 branches to “Yes” branch 522 which loops back to move to the child object at step 530. This looping continues until processing reaches the last child object in the particular branch, at which point decision 520 branches to “No” branch 528.

A determination is made as to whether the child object is a FLWOR object (decision 540). If the child object is not a FLWOR object, decision 540 branches to “No” branch 542 bypassing XPath conversion steps. On the other hand, if the object is a FLWOR object, decision 540 branches to “Yes” branch 548 whereupon a determination is made as to whether the FLWOR object is convertible based upon convertibility rules (decision 550). For example, the convertibility rules may include:
The FLWOR object includes only one RETURN and one FOR expression, and the path for the RETURN expression is:
   The same as the FOR expression.
   A descendent of the FOR expression.
   A direct ancestor of the FOR expression.
The FLWOR object contains one RETURN expression, one FOR expression, and WHERE expressions with the following rules:
   The rules for the RETURN expressions are same as the one for a single RETURN expressions and FOR expressions.
   The WHERE expression contains only XPath expressions or constants.

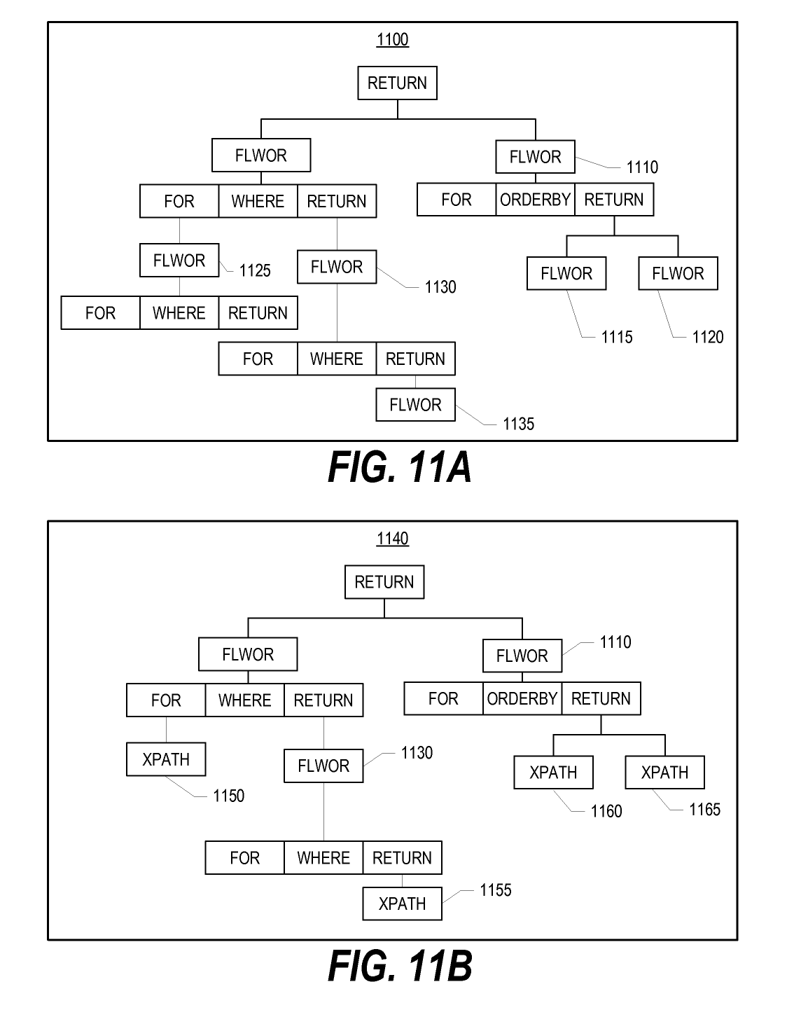

If the object is not convertible based upon the convertibility rules, decision 550 branches to “No” branch 552 bypassing conversion steps. On the other hand, if the object is convertible, decision 550 branches to “Yes” branch 558 whereupon processing converts the FLWOR object to an XPath object at step 560 using conversion rules (see FIGS. 11A, 11B, and corresponding text for further details). For example, the conversion rules may include:
The FLWOR object contains only one RETURN and one FOR expression, and the path for the RETURN expression is the same as the FOR expression, then:
   Conversion rule—Return the path defined by the FOR expression.
The FLWOR object contains only one RETURN and one FOR expression and the path for the RETURN expression is a descendent of the FOR expression, then:
   Conversion rule—Return the path defined by the FOR expression plus the difference between the FOR and the return paths.

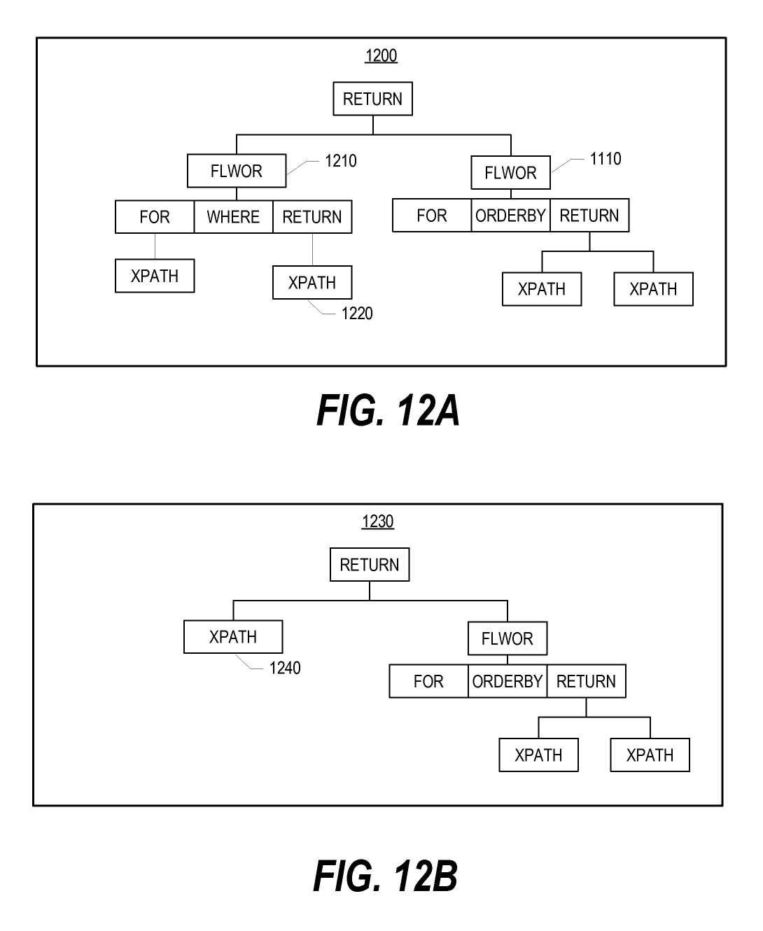

A determination is made as to whether processing should continue to recursively search for, and convert, FLWOR objects (decision 570). If processing should continue, decision 570 branches to “Yes” branch 572 which loops back and moves up to the parent object (step 580), and selects the next child object (step 530) (see FIGS. 12A, 12B, and corresponding text for further details). This looping continues until processing should stop recursively searching for, and converting, FLWOR objects, at which point decision 570 branches to “No” branch 578 whereupon processing returns at 590.

FIG. 6 is a flowchart showing steps taken in creating runtime parameters for an XQuery using XML source documents. Processing commences at 600, whereupon processing selects a first document node from a query model located in query model store 150 (step 610). Query model store 150 is the same as that shown in FIG. 1. A determination is made as to whether the node's corresponding document is used in the query (decision 620). For example, the node may include:
<document column=““id=””includeschema=““schema=””table=““uri=”C:/cascade/eclipse/runtime−workspace/XqueryTest/Documentl.xml”url=“““usedfor=“xpath”/>
   whereby the “usedfor” attribute is set to “xpath” whenever a node from that document is used. If the document is not used in the query, decision 620 branches to “No” branch 622 bypassing code generation steps. On the other hand, if the document is used in the query, decision 620 branches to “Yes” branch 628.

A determination is made as to whether the document is bound to a file (decision 630). In the above example, processing checks of the table and column attributes are empty. If they are empty, processing knows that the document is going to be passed into the query. If the document is not bound to a file, decision 630 branches to “No” branch 632 bypassing code generation steps. On the other hand, if the document is bound to a file, decision 630 branches to “Yes” branch 638 whereupon processing generates code for a runtime parameter in the query, and stores it in XQuery store 170 (step 640). XQuery store 170 is the same as that shown in FIG. 1.

A determination is made as to whether there are more objects to process in the query model that is located in query model store 150 (decision 650). If there are more objects to process, decision 650 branches to “Yes” branch 652 whereupon processing selects (step 660) and processes the next object. This looping continues until there are no more objects to process, at which point decision 650 branches to “No” branch 658 whereupon processing returns at 670.

FIG. 7 is a flowchart showing steps taken in passing documents as runtime parameters to a query engine during an XQuery execution. Processing commences at 700, whereupon processing creates a prepared statement using an XQuery stored in XQuery store 170, and sends the prepared statement to query engine 180 (step 710). XQuery store 170 and query engine 180 are the same as that shown in FIG. 1. At step 720, processing selects a first object included in the XQuery at step 720. A determination is made as to whether the object's corresponding XML document is used in the query (decision 730). If the object's corresponding XML document is not used in the query, decision 730 branches to “No” branch 732 bypassing document passing steps. On the other hand, if the object's corresponding document is used in the query, decision 730 branches to “Yes” branch 738.

A determination is made as to whether the document is bound to a file (decision 740). If the document is not bound to a file, decision 740 branches to “No” branch 742 bypassing document passing steps. On the other hand, if the document is bound to a file, decision 740 branches to “Yes” branch 748 whereupon processing passes the document as a runtime parameter to query engine 180 for use during the prepared statement's execution (step 750).

A determination is made as to whether there are more objects in the XQuery to process (decision 760). If there are more objects to process, decision 760 branches to “Yes” branch 762 which loops back to select (step 770) and process the next object. This looping continues until there are no more objects to process, at which point decision 760 branches to “No” branch 768.

At step 780, processing executes the query using the prepared statement and the runtime parameters. In turn, query engine 180 produces results 190, which is the same as that shown in FIG. 1. Processing returns at 790.

FIG. 8A is a general user interface (GUI) window that allows a user to select a node to replicate into a query model. When a user creates an XQuery, the user specifies an XML structure of the XQuery's results. Window 800 allows a user to easily generate the structure by replicating nodes that are located in existing XML documents.

Window 800 allows a user to indicate nodes of a target XML structure to replicate by dragging the node at the root of that structure to a query design area. A user selects a particular document using selection window 810, such as “purchaseOrder.xml.” The user may then “right click” a pointer, which displays menu 820 on window 800. In turn, the user positions pointer 830 over “replicate node structure.” This action instructs an XQuery builder to add query logic to a query model that corresponds to the node.

FIG. 8B is a user interface window showing an instance document node replicated in a query model. Window 800 includes replicated node 840, which was replicated in FIG. 8A. A user may continue to drag nodes from instance documents representing source schema into the query design area, thus easily creating a query model that includes replicated nodes. As a result, the query model returns XML documents that are valid according to a predetermined schema, built from a replication of instance of that schema, and also include dynamic content from existing XML data sources.

FIG. 9 is a window showing query model code that includes XPath elements. Window 900 includes XPath elements 910 through 940, which are modified to include relative paths during query model optimization (see FIGS. 3, 4, 10A, 10B, and corresponding text for further details).

FIG. 10A is a window showing query model code that includes annotated XPath elements. Window 1000 includes code lines 1010 through 1040, which are XPath elements 910 through 940, respectively, that have been annotated during query model optimization (see FIG. 3 and corresponding text for further details).

FIG. 10B is a window showing query model code that includes annotated XPath elements and relative paths.

Window 1050 includes code lines 1060 through 1090 that correspond to code lines 1010 through 1040, respectively, shown in FIG. 10A. Code lines 1060 through 1090 include appended variable names in order to create relative paths for the XPath elements (see FIG. 4 and corresponding text for further details).

FIG. 11A is a diagram showing a query model hierarchy that includes FLWOR objects. As discussed in FIG. 5, a FLWOR object may include other FLWOR objects. These, in turn, may also include FLWOR objects. In order to convert FLWOR objects to XPath objects, processing recursively traverses this hierarchy starting from the innermost FLWOR object, whose results are shown in FIGS. 11B, 12A, and 12B.

Diagram 1100 includes FLWOR objects 1110, through 1135. To begin the recursive process, a query builder identifies and converts FLWOR objects 1125, 1115, 1120, and 1135 to XPath objects. The query builder then proceeds up the hierarchy to convert the other FLWOR objects (see FIG. 11B, 12A, and 12B and corresponding text for further details).

FIG. 11B is a diagram showing a first recursive step result for converting FLWOR objects to XPath objects.

Diagram 1140 shows that an XQuery builder converted FLWOR objects 1125, 1115, 1120, and 1135 shown in FIG. 11A into XPath objects 1150, 1160, 1165, and 1155, respectively. Now that these objects are converted, the XQuery builder may continue its recursive process and determine whether FLWOR objects 1130 and 1110 are convertible.

Since FLWOR object 1130 passes particular conversion rules, the XQuery builder may convert FLWOR object 1130 to an XPath object. FLWOR object 1110, however, may not be converted because it includes an ORDERBY object with two “returns” (see FIG. 12A and corresponding text for further details).

FIG. 12A is a diagram showing a second recursive step result for converting FLWOR objects to XPath objects.

Diagram 1200 shows that an XQuery builder converted FLWOR object 1130 shown in FIG. 11A into XPath 1220. As can be seen, the XQuery builder did not convert FLWOR object 1110 because it did not pass convertibility rules. The next recursive step is for the XQuery builder to determine whether FLWOR object 1210 is convertible. Since it passes convertibility rules, the XQuery builder performs the conversion (see FIG. 12B and corresponding text for further details).

FIG. 12B is a diagram showing a third recursive step result for converting FLWOR objects to XPath objects. Diagram 1230 shows that an XQuery builder converted FLWOR object 1210 shown in FIG. 12A into XPath 1240, and the XQuery builder's FLWOR object to XPath object conversion process is complete.

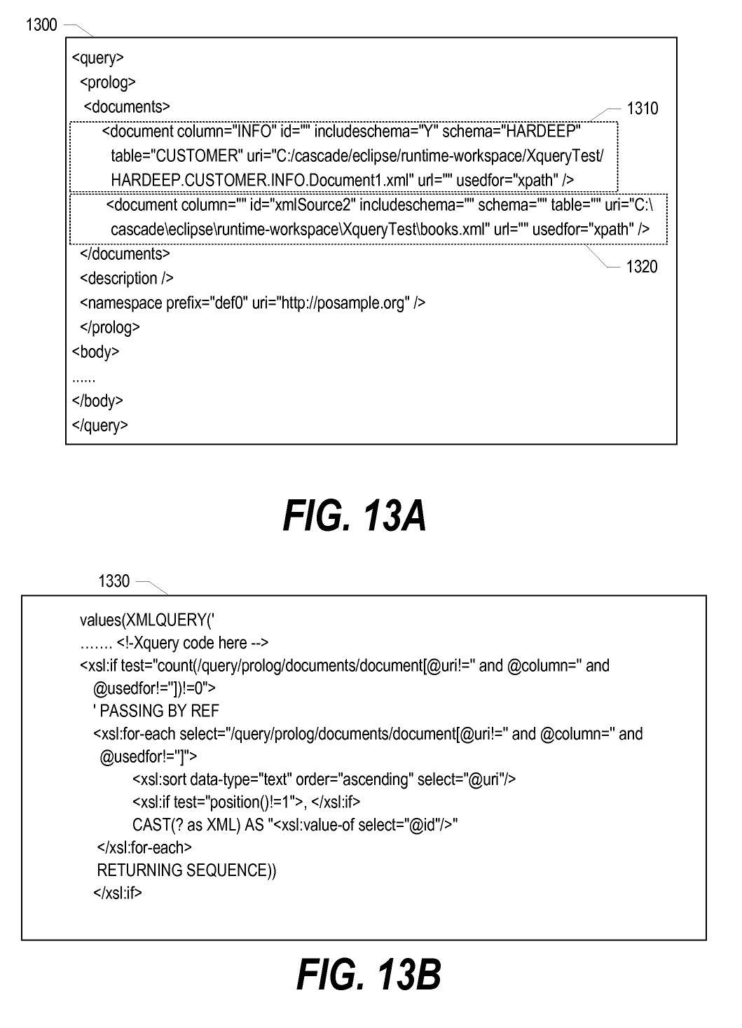

FIG. 13A is a window showing a query model in XML that includes document information. Window 1300 includes code lines 1310 and 1320. As can be seen, code line 1310 includes column and table attributes pointing to a relational table and column in a database. Code line 1320, however, does not include these column and table attributes. When an XQuery builder parses a query model to generate an XQuery, the XQuery builder uses the information to determine that code line 1320 represents an input parameter to the query, while code line 1310 represents XML data in a target data source column on which the query runs.

FIG. 13B is a window showing a XSLT code for use in generating a parameterized query. The XSLT code shown in window 1330 is an example of code that may be executed when a corresponding SQL/XML wrapper is generated in order to generate a parameterized query.

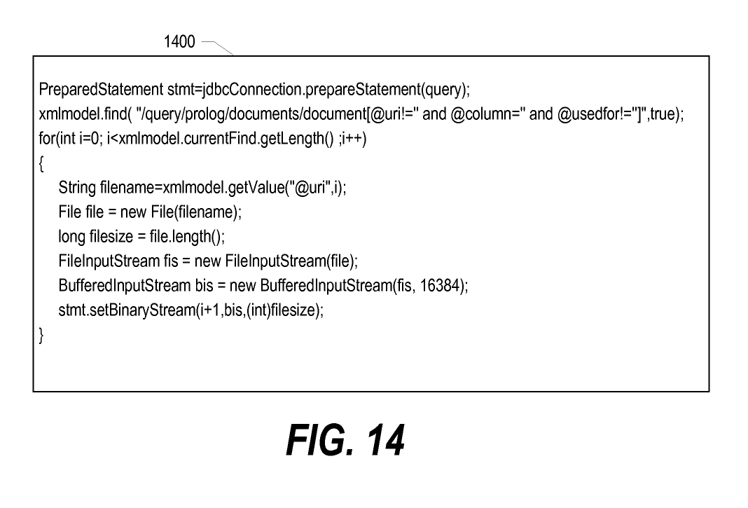

FIG. 14 is a window showing an example of Java code for use in passing example documents to a query engine during query execution. During query execution, instance documents may be passed to a query engine using the example code shown in window 1400 when the instance documents are used in the query and bound to a file (see FIG. 7 and corresponding text for further details).

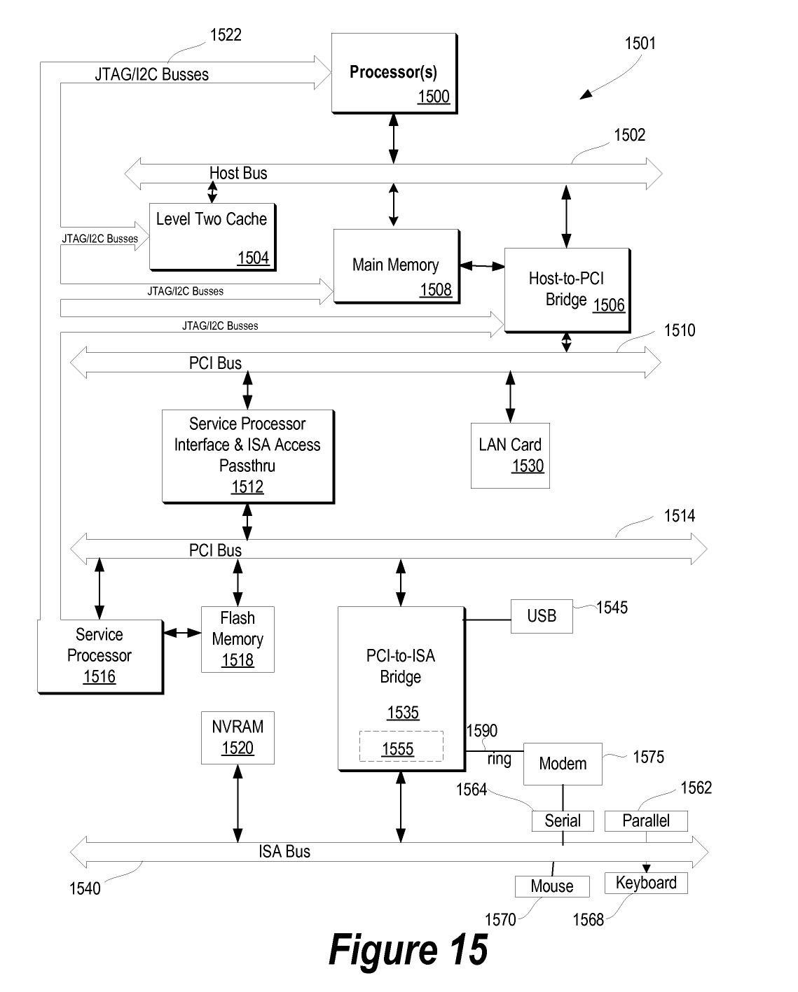

FIG. 15 illustrates information handling system 1501 which is a simplified example of a computer system capable of performing the computing operations described herein. Computer system 1501 includes processor 1500 which is coupled to host bus 1502. A level two (L2) cache memory 1504 is also coupled to host bus 1502. Host-to-PCI bridge 1506 is coupled to main memory 1508, includes cache memory and main memory control functions, and provides bus control to handle transfers among PCI bus 1510, processor 1500, L2 cache 1504, main memory 1508, and host bus 1502. Main memory 1508 is coupled to Host-to-PCI bridge 1506 as well as host bus 1502. Devices used solely by host processor(s) 1500, such as LAN card 1530, are coupled to PCI bus 1510. Service Processor Interface and ISA Access Pass-through 1512 provides an interface between PCI bus 1510 and PCI bus 1514. In this manner, PCI bus 1514 is insulated from PCI bus 1510. Devices, such as flash memory 1518, are coupled to PCI bus 1514. In one implementation, flash memory 1518 includes BIOS code that incorporates the necessary processor executable code for a variety of low-level system functions and system boot functions.

PCI bus 1514 provides an interface for a variety of devices that are shared by host processor(s) 1500 and Service Processor 1516 including, for example, flash memory 1518. PCI-to-ISA bridge 1535 provides bus control to handle transfers between PCI bus 1514 and ISA bus 1540, universal serial bus (USB) functionality 1545, power management functionality 1555, and can include other functional elements not shown, such as a real-time clock (RTC), DMA control, interrupt support, and system management bus support. Nonvolatile RAM 1520 is attached to ISA Bus 1540. Service Processor 1516 includes JTAG and I2C busses 1522 for communication with processor(s) 1500 during initialization steps. JTAG/I2C busses 1522 are also coupled to L2 cache 1504, Host-to-PCI bridge 1506, and main memory 1508 providing a communications path between the processor, the Service Processor, the L2 cache, the Host-to-PCI bridge, and the main memory. Service Processor 1516 also has access to system power resources for powering down information handling device 1501.

Peripheral devices and input/output (I/O) devices can be attached to various interfaces (e.g., parallel interface 1562, serial interface 1564, keyboard interface 1568, and mouse interface 1570 coupled to ISA bus 1540. Alternatively, many I/O devices can be accommodated by a super I/O controller (not shown) attached to ISA bus 1540.

In order to attach computer system 1501 to another computer system to copy files over a network, LAN card 1530 is coupled to PCI bus 1510. Similarly, to connect computer system 1501 to an ISP to connect to the Internet using a telephone line connection, modem 15155 is connected to serial port 1564 and PCI-to-ISA Bridge 1535.

While FIG. 15 shows one information handling system that employs processor(s) 1500, the information handling system may take many forms. For example, information handling system 1501 may take the form of a desktop, server, portable, laptop, notebook, or other form factor computer or data processing system. Information handling system 1501 may also take other form factors such as a personal digital assistant (PDA), a gaming device, ATM machine, a portable telephone device, a communication device or other devices that include a processor and memory.

One of the preferred implementations of the invention is a client application, namely, a set of instructions (program code) in a code module that may, for example, be resident in the random access memory of the computer. Until required by the computer, the set of instructions may be stored in another computer memory, for example, in a hard disk drive, or in a removable memory such as an optical disk (for eventual use in a CD ROM) or floppy disk (for eventual use in a floppy disk drive), or downloaded via the Internet or other computer network. Thus, the present invention may be implemented as a computer program product for use in a computer. In addition, although the various methods described are conveniently implemented in a general purpose computer selectively activated or reconfigured by software, one of ordinary skill in the art would also recognize that such methods may be carried out in hardware, in firmware, or in more specialized apparatus constructed to perform the required method steps.

While particular embodiments of the present invention have been shown and described, it will be obvious to those skilled in the art that, based upon the teachings herein, that changes and modifications may be made without departing from this invention and its broader aspects. Therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

What is claimed is:

1. A computer-implemented method comprising:
identifying a first object in a query model;
determining that the first object is an XPath object;
creating a relative path for the XPath object, the relative path corresponding to a hierarchical location of the XPath object relative to a second object included in the query model;
including the relative path in the query model;
generating an XQuery using the query model that includes the relative path; and
executing the XQuery using a query engine.

2. The method of claim 1 wherein the creating further comprises:
annotating, for the XPath object, an absolute path in the query model, a parent's absolute path, and a model tree level, the parent's absolute path corresponding to a parent object of the XPath object;
including the absolute path, the parent's absolute path, and the model tree level in the relative path;
determining whether the XPath object represents a variable; and
in response to determining that the XPath object represents a variable, annotating a variable name and a variable type corresponding to the variable, and including the variable name and the variable type in the relative path.

3. The method of claim 2 further comprising:
selecting a nearest ancestor to the XPath object;
identifying a nearest ancestor variable path offset corresponding to the selected nearest ancestor; and
including the nearest ancestor variable path offset in the relative path.

4. The method of claim 1 further comprising:
identifying a For-Let-Where-Orderby-Return (FLWOR) object in the query model;
determining that the FLWOR object is convertible to an XPath object based upon one or more convertibility rules; and
in response to the determining that the FLWOR object is convertible to the XPath object, converting the FLWOR object to the XPath object using one or more conversion rules.

5. The method of claim 1 further comprising:
identifying an XML instance document;
selecting a node included in the XML instance document; and
replicating the node into the query model using a general user interface, the replicating resulting in the first object.

6. The method of claim 5 further comprising:
determining that the XLM instance document is used during query execution and the XML instance document is bound to a file;
in response to determining that the XLM instance document is used during query execution and the XML instance document is bound to a file, generating a runtime parameter corresponding to the XML instance document; and
including the runtime parameter in the XQuery.

7. The method of claim 6 further comprising:
in response to determining that the XLM instance document is used during query execution and the XML instance document is bound to a file, passing the XML document as a runtime parameter to the query engine during the query execution.

8. A computer program product stored on a computer operable media, the computer operable media containing instructions for execution by a computer, which, when executed by the computer, cause the computer to implement a method for generating and executing an XQuery, the method comprising:
identifying a first object in a query model;
determining that the first object is an XPath object;
creating a relative path for the XPath object, the relative path corresponding to a hierarchical location of the XPath object relative to a second object included in the query model;
including the relative path in the query model;
generating an XQuery using the query model that includes the relative path; and
executing the XQuery using a query engine.

9. The computer program product of claim 8 wherein the method further comprises:
annotating, for the XPath object, an absolute path in the query model, a parent's absolute path, and a model tree level, the parent's absolute path corresponding to a parent object of the XPath object;
including the absolute path, the parent's absolute path, and the model tree level in the relative path;
determining whether the XPath object represents a variable; and
in response to determining that the XPath object represents a variable, annotating a variable name and a variable type corresponding to the variable, and including the variable name and the variable type in the relative path.

10. The computer program product of claim 9 wherein the method further comprises:
selecting a nearest ancestor to the XPath object;
identifying a nearest ancestor variable path offset corresponding to the selected nearest ancestor; and
including the nearest ancestor variable path offset in the relative path.

11. The computer program product of claim 8 wherein the method further comprises:
identifying a For-Let-Where-Orderby-Return (FLWOR) object in the query model;
determining that the FLWOR object is convertible to an XPath object based upon one or more convertibility rules; and
in response to the determining that the FLWOR object is convertible to the XPath object, converting the FLWOR object to the XPath object using one or more conversion rules.

12. The computer program product of claim 8 wherein the method further comprises:
identifying an XML instance document;
selecting a node included in the XML instance document; and
replicating the node into the query model using a general user interface, the replicating resulting in the first object.

13. The computer program product of claim 12 wherein the method further comprises:
determining that the XLM instance document is used during query execution and the XML instance document is bound to a file;
in response to determining that the XLM instance document is used during query execution and the XML instance document is bound to a file, generating a runtime parameter corresponding to the XML instance document; and
including the runtime parameter in the XQuery.

14. The computer program product of claim 13 wherein the method further comprises:
in response to determining that the XLM instance document is used during query execution and the XML instance document is bound to a file, passing the XML document as a runtime parameter to the query engine during the query execution.

15. An information handling system comprising:
one or more processors;
a memory accessible by the processors;
one or more nonvolatile storage devices accessible by the processors; and
an XQuery builder tool for generating and executing an XQuery, the XQuery builder tool being effective to:
identify a first object in a query model located in one of the nonvolatile storage devices;
determine that the first object is an XPath object;
create a relative path for the XPath object, the relative path corresponding to a hierarchical location of the XPath object relative to a second object included in the query model;
include the relative path in the query model;
generate an XQuery using the query model that includes the relative path; and
execute the XQuery using a query engine.

16. The information handling system of claim 15 wherein the XQuery builder tool is further effective to:
annotate, for the XPath object, an absolute path in the query model, a parent's absolute path, and a model tree level, the parent's absolute path corresponding to a parent object of the XPath object;
include the absolute path, the parent's absolute path, and the model tree level in the relative path;
determine whether the XPath object represents a variable; and
in response to determining that the XPath object represents a variable, annotate a variable name and a variable type corresponding to the variable, and including the variable name and the variable type in the relative path.

17. The information handling system of claim 16 wherein the XQuery builder tool is further effective to:
select a nearest ancestor to the XPath object;
identify a nearest ancestor variable path offset corresponding to the selected nearest ancestor; and
include the nearest ancestor variable path offset in the relative path.

18. The information handling system of claim 15 wherein the XQuery builder tool is further effective to:
identify a For-Let-Where-Orderby-Return (FLWOR) object in the query model;
determine that the FLWOR object is convertible to an XPath object based upon one or more convertibility rules; and
in response to the determining that the FLWOR object is convertible to the XPath object, convert the FLWOR object to the XPath object using one or more conversion rules.

19. The information handling system of claim 15 wherein the XQuery builder tool is further effective to:
identify an XML instance document located in one of the nonvolatile storage devices;
select a node included in the XML instance document; and
replicate the node into the query model using a general user interface, the replicating resulting in the first object.

20. The information handling system of claim 19 wherein the XQuery builder tool is further effective to:
determine that the XLM instance document is used during query execution and the XML instance document is bound to a file;
in response to determining that the XLM instance document is used during query execution and the XML instance document is bound to a file:
generate a runtime parameter corresponding to the XML instance document;
pass the XML document as a runtime parameter to the query engine during the query execution; and include the runtime parameter in the XQuery.
